(19) United States
(12) Patent Application Publication
(10) Pub. No.: US 2021/0244145 A1
(43) Pub. Date: Aug. 12, 2021

(54) Card Cover

(71) Applicant: Richard Stewart, III, Springfield, OH (US)

(72) Inventor: Richard Stewart, III, Springfield, OH (US)

(21) Appl. No.: 16/933,007

(22) Filed: Jul. 20, 2020

Related U.S. Application Data
(60) Provisional application No. 62/971,156, filed on Feb. 6, 2020.

(51) Int. Cl. A45C 11/18; A45C 1/06; B42D 25/23

(52) U.S. Cl. CPC A45C 11/182; A45C 1/06; A45C 2200/10; A45C 2001/065; B42D 25/23

(57) ABSTRACT

This present patent application discloses a card cover. The card cover comprises of a front and a back panel including various gray-out and transparent portions. The card cover provides users with a privacy cover for identification cards, debit and credit cards, and more, and maintains privacy for the user, preventing personal information from being revealed to unauthorized individuals when using the card. The device features several ‘gray-out’ portions on the cover to protect information on the card and ensures bystanders, retail employees, and the like are unable to view specific information, preventing identity theft and other dangers involving personal information. The transparent portion shows the non-confidential information present on the card for easy access of the card.

### CROSS-REFERENCE TO RELATED APPLICATION

The present application claims priority to, and the benefit of, U.S. Provisional Application No. 62/971,155, which was filed on Feb. 6, 2020 and is incorporated herein by reference in its entirety.

### BACKGROUND

The present invention relates generally relates to the field of card covers and more particularly to a privacy card cover having a structure that covers a card to hide or obscure confidential information present on the front face and/or back face of the card. The card cover of the present invention ensures the safety of identification cards such as driver's license, passport, student identification, patient identification, credit cards and the like, and prevents personal and confidential information printed, embossed, or otherwise displayed thereon the cards from getting revealed or exposed to unauthorized individuals. Accordingly, the present specification makes specific reference to the present invention and it is to be appreciated that aspects of the present invention are also equally amenable to other like applications, devices and methods of manufacture.

In recent years, use and prevalence of various types of cards such as Identity cards, Driver's license, Debit cards, Credit cards, Gift cards, etc. has increased many times. Such cards often have personal and confidential information imprinted or embossed on them, which may leave the owner at risk for identity theft. Further, in case an unauthorized person gets access to the card and the personal information available on the card, the unauthorized user can easily steal the owner identity information making the owner vulnerable to potentially severe financial and other consequences. Moreover, the cards usually include magnetic stripe, codes and other information, which can become quickly tampered with or damaged, if exposed to water, rain, etc. thereby leaving the card unusable.

Credit and debit card fraud is a prevailing fear among consumers as identity theft incidents rise. Unauthorized persons such as criminals, bystanders, pedestrians, retail employees can view a card in a store by standing near a customer and can learn the confidential information printed or embossed on these cards. Using the confidential information, any other person may make unauthorized purchases, drain bank accounts and use the information to potentially pry deeper into the user's life.

Anytime an identification card, credit card or debit card is used to show identity or to perform a transaction, it must necessarily be brought into public view or exposed to scanners, readers or other equipment that can be used to lift valuable information. However, such cards usually contain significant and valuable sensitive information which the user would not otherwise want to display publicly and risk the data being compromised. For example, when a restaurant patron wishes to pay with a credit card or debit card, he or she typically places the card on the table, in a card folio or on a small tray until the server comes to collect the card. During this time, any passerby or bystander who also happens to be in the restaurant may be able to observe the card, including the sensitive information displayed thereon. Not to mention, the server or other employees of the restaurant or service location may also be tempted to utilize the information. The passerby may use the sensitive card information for unwanted and illegal reasons. In the foregoing example and in numerous other ordinary, commonplace, and frequent transactions, the sensitive confidential information and personal identity of a user is exposed and potentially compromised through several avenues.

By the way of background, there exists some covers such as card holders, card sleeves, card wallets, which provide a limited solution to the increasing problem of information theft and maintaining data integrity. The existing card holders further protect the cards from being tampered with are manufactured using materials such as steel, leather, plastic, vinyl, etc. Generally, steel card holders are hard enough to protect the card from damage and are usually opaque which does not allow any unauthorized person to view the sensitive information on the cards. Some card holders have multiple sleeves to keep multiple cards together, in order to provide convenience to the users in carrying all of his or her cards together. However, due to opaqueness of the multi-sleeve card holder, the owner is unable to know which card is kept inside which card holder sleeve requiring the user to have to search for the particular card that the user would like to use in a specific transaction. The user has to take out all the cards from their respective sleeves one-by-one to get the required card at the time of use. This whole process is time taking, frustrating and tiresome for the user. Further, usually steel card covers are thick and therefore makes it difficult for the user to carry the card cover in wallets or pockets. Such metal card carriers can also be inconvenient when going through airport or other security screening points as the metal card holder will normally set off the alarm on the equipment.

Some transparent card covers such as vinyl wallets, plastic wallet inserts, etc. are also available in the market today which allows the user to easily view the required card kept inside the card cover. Although, the transparent card cover enables the user to quickly access the required card, the transparency of the card cover leaves the card unsecure when used in any public places. Any bystander, passerby, pedestrians, retail employees and the like may easily view and observe the sensitive card information through the transparent card cover and further misuse the information. The unauthorized person may easily steal the confidential information on identity cards to show fake ID on any illegal papers, and other similar situations, leaving the owner with a problem in having to restore his or her identity. Further, the unauthorized person may utilize the information on credit cards, debit cards, gift cards, etc. to make unwanted transactions, thereby causing financial harm to the owner of the card and the financial institution issuing the card that may have to pay for the claim.

Additionally, the conventional card covers are either completely opaque, or transparent or translucent in composition. Completely opaque or completely transparent card covers pose disadvantages to the user's inconvenience and identity theft respectively. In a similar manner, completely translucent card holders are semi-transparent, and therefore allow any other user to observe the confidential information with little effort.

Therefore, there exists a long felt need in the art for a device which enables a user to protect sensitive personal and confidential information available on the cards such as identity cards, driving license, credit cards, debit cards, frequent traveler cards, loyalty cards, passport cards, etc. There is also a long felt need in the art for a case cover which makes the card easily and readily available to a user when a card is needed for a transaction. There is also a long felt need in the art for a card cover which prevents damage to the card when exposed to water, or other elements, etc. that may cause delamination of the card, discoloration or other situations detrimental to the card. Also, there is also a long felt need in the art for a card cover with customized surface texture to prevent a third party from engaging in criminal activity or identity theft. Finally, there is a long felt need in the art for a thin, sleek and unique card cover design which secures the owner's private and confidential information and data from any unauthorized persons or inadvertent use.

The subject matter disclosed and claimed herein, in one embodiment thereof, comprises a card cover. The card cover is a generally rectangular shaped plastic casing with a plurality of protective portions and transparent portions. Of course, other shapes may be used if the card to be protected is of a shape other than rectangular or the casing can take on a shape of a theme having a card portion and an auxiliary themed portion. The protective portion is in one embodiment an opaque textured area which does not allow any person to view personal and/or confidential information hidden behind the protective portion and therefore prevents the information from being stolen and used inappropriately and without permission. Further, the transparent portion of the card case allows a user to view through the card case and access a non-essential information on the card such as photo of the owner, etc., and further, makes it convenient for the user to recognize a required card such as by allowing a logo or name of an issuing institution to be visible. Importantly, the card cover provides easy access to the card as well as prevents the user's confidential information from being seen by others.

In this manner, the card cover of the present invention accomplishes all of the forgoing objectives, and provides a secure and convenient solution to protect confidential information on the card according to the preferences and needs of the user. The improved card cover of the present invention is preferably thin, partly opaque and partly transparent, non-adhesive and water-proof which minimizes the risk of tampering and information theft. Finally, the improved card cover of the present invention is available in different sizes, shapes and with customized gray-out, concealment, or protective areas to specifically fulfil the user preferences, needs and requirements.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a card cover having a structure to insert a card such as identity cards, credit or debit cards, gift cards, driver's license, frequent traveler cards, loyalty cards, passport cards, etc. inside it and protect the sensitive and confidential information thereon. The card cover is attachable and detachable from the card as needed. The unique structure of the card cover eliminates the ability of unwanted parties to read, scan and steal information from a card while it is exposed.

In an embodiment, the card cover comprises a front panel and a back panel, which aligns and is generally co-extensive with a front and a back portion of the card when inserted inside the cover. The card cover may be slightly larger than the card itself to allow easy removal. Further, the front panel and the back panel of the card cover includes protective portions and transparent portions at specific locations. The specific locations of the protective portion overlaps with position of the sensitive information on the card or other information the user desires to conceal and hides it, thereby preventing the confidential personal information from being exposed to unauthorized persons. Further, the transparent portion facilitates easy access to the non-confidential information available on the cards kept inside the card cover. The improved design of the card cover protects users against identity theft and provides easy access of the cards kept inside the card cover.

In yet another embodiment of the present invention, a low-profile card cover that does not interfere with normal use of the credit card or a debit card is disclosed. The card cover of the present invention provides enhanced security and additional features not found in the prior art covers. In the case of a credit card or a debit card, the personal sensitive information often includes the user's name, account number or card number, and a security code. Additionally, the card includes an EMV chip on the front face and a magnetic strip on the back face thereof which encodes some of the sensitive information, typically the account number, and which may be read by a machine to automate part of the desired transaction. The front panel of the card cover obscures or hide a substantial portion of the sensitive information present on the front face of the card. The disclosed card cover of the present information also does not obscure the magnetic strip and the EMV chip or otherwise interfere with the use thereof when the card is swiped or “dipped” toward the terminal in order to read the embedded chip. When credit card or a debit card is enclosed in the card cover, the front panel and the back panel will obscure the most or all common locations of the personal sensitive information from view and otherwise protected from misappropriation.

In a further embodiment of the present invention, the card cover includes an open edge for inserting the card inside the card cover. In a preferred embodiment, the opening is provided on a top edge of the card cover enabling a card to easily slip inside the card cover from the top portion. In other embodiments, the opening can be provided at any other edges such as left, right, bottom of the card covers to enable the user to put the card inside card cover through the specific open edge. In yet a further embodiment, a plurality of single protective card covers catering to different types of card inserts may also be bound together along one edge common to all the individual units of single card cover.

In one exemplary embodiment of the presently described invention, a card carrier is provided and includes at least two card covers with each of the card covers having front and back panels with each of the panels having top, bottom, left and right edges and the card cover being sealed along at least two of the edges. Each of the card covers having at least one concealment area and at least one transparent area the at least one concealment area covering the partly confidential personal information and the at least one transparent area covering the generally non-confidential information. The at least two card covers being secured to one another along on of the top, bottom, left and right edges to form a card carrier for multiple cards.

In a further exemplary embodiment of the presently described invention, a card cover, is provided and includes front and back panels each sized and configured to substantially cover a card, and each of the front and back panels have top and bottom edges and left and right side edges with at least two of the top and bottom edges and left and right side edges being secured together, The card having at least one area having confidential information and one or more areas having non-confidential information. The at least one concealment or black or gray out area provided on one of the front and back panels and the at least one concealment or black or gray out area being sized and configured to cover the at least one area of confidential information. A cover and card combination, is described and includes a card having front and back panels with information relating to a user disposed on at least one of the front or back panels and information relating to a card issuer disposed on one of the front or back panels of the card. The information relating to the user being at least partly confidential personal information and the information relating to a card issuer being generally non-confidential information.

A card cover having front and back panels with each of the panels having top, bottom, left and right edges and the card cover being sealed along at least two of the edges. The card cover having at least one concealment area and at least one transparent area. The at least one concealment area covering the partly confidential personal information and the at least one transparent area covering the generally non-confidential information.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1a illustrates a front view of a conventional sample driver license card of the present invention in accordance with the disclosed structure;

FIG. 1b illustrates a back view of a conventional sample driver license card of the present invention in accordance with the disclosed structure.

FIG. 2 illustrates a front view of the card cover of the present invention in accordance with the disclosed structure;

FIG. 3a illustrates a front-panel of the card cover of the present invention in accordance with the disclosed structure;

FIG. 3b illustrates a back-panel of the card cover of the present invention in accordance with the disclosed structure;

FIG. 4 illustrates a perspective view of inserting a card through an opening of the card cover of the present invention in accordance with the disclosed structure;

FIG. 5 illustrates a front view of a card inside the card cover hiding confidential information and displaying non-confidential information for use of the present invention in accordance with the disclosed structure;

FIG. 6a illustrates a different designs of a card covers of the present invention in accordance with the disclosed structure;

FIG. 6b illustrates a different design of a card cover of the present invention in accordance with the disclosed structure;

FIG. 7 illustrates a perspective view of a multi-sleeve protective card cover of the present invention comprising a plurality of protective covers bound on one common edge in accordance with the disclosed structure;

FIG. 8a illustrates perspective view of a front of a debit card;

FIG. 8b illustrates a perspective view of a back of a debit card;

FIG. 8c illustrates a perspective view of a front of a debit card with an embodiment of the card cover of the present invention applied thereto; and

FIG. 8d illustrates a perspective view of a back of a debit card with an embodiment of the card cover of the present invention applied thereto.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists in the art a long felt need in the art for a unique card cover that protects the confidential user information such as name, address, account number, etc. from being revealed to any unauthorized individuals, and at the same time allows the user and other authorized persons to view the non-confidential information such as identity photo, etc. present on the card. There also exists in the art a long felt need in the art to have a thin, non-adhesive plastic film cover for identification cards, credit cards, frequent traveler cards, loyalty cards, passport cards, and more. There is also a long felt need in the art for a case cover which makes the card easily and readily available to a user. Finally, there is also a long felt need in the art for a card cover which prevents the card from tampering when exposed to water, etc.

The innovative product of the present invention features a secure card cover that is comprised of a front panel and a back panel having a protective coating such as a gray or black out area and a transparent area designed to be located at specific locations of the card surface such that it enables the card cover to hide confidential and sensitive personal user information contained on the card front or back from being revealed to unauthorized users such as pedestrians, bystanders, etc. and allows only non-confidential user information to be displayed through the card cover via the transparent areas. The protective coating, overprint or gray or black out area(s) may include a privacy film or a tinted film, printing or coating that distorts, darkens, or blackens the portion of cover for the areas of the card that it covers. Further, the different patterns for the protective area may be included to conceal or further reduce the readability or visibility of the information on the card. The customized card cover comes in different sizes and shapes to accommodate different types of cards such as Driving license, Identity Cards, Credit/Debit Cards, Gift cards, frequent traveler cards, loyalty cards, passport cards, etc. and fulfil the user needs. The card cover of the present invention provides a more convenient and secure holder for users to protect the cards and carry them conveniently.

The present invention, in one exemplary embodiment, is an improved card cover or carrier having a front panel and a back panel comprising of one or more protective areas and one or more transparent or translucent areas. When card is slipped inside the card cover or carrier, the protective area(s) overlaps one or more confidential information areas such as user name, address, signature, card number, pin number, etc. and the transparent area(s) overlaps one or more non-confidential information areas such as identity photo printed, issuing agency or embossed logos on the card and therefore allows the user to view only non-confidential information areas through the card cover or carrier, and hide the confidential or conceal the information from others. Accordingly, the present invention has advantages to secure the card information from any unauthorized persons such as bystanders, pedestrians, retail employees, etc. and prevent misuse of user's confidential information. Furthermore, the card cover is water-resistant and aims to protect the card from getting damaged or destroyed in rain, water, or other deleterious environmental effects, etc.

These and other advantages of the present subject matter would be described in greater detail with reference to the following figures. It should be noted that the description merely illustrates the principles of the present subject matter. It will thus be appreciated that those skilled in the art will be able to devise various arrangements that, although not explicitly described herein, embody the principles of the present subject matter and are included within its scope.

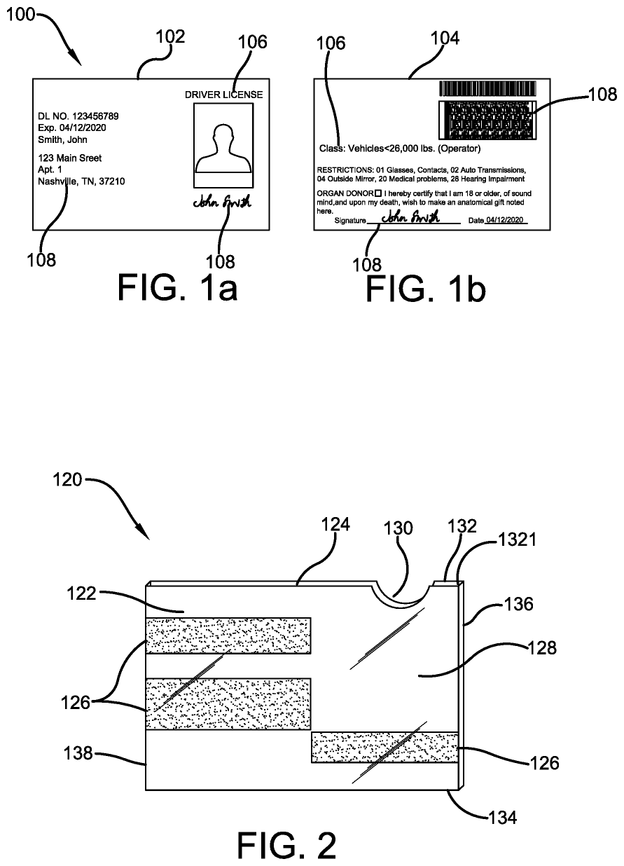

Referring initially to the drawings, FIG. 1 illustrates a front view and a back view of a conventional sample driver license card of the present invention in accordance with the disclosed structure. FIG. 1(a) discloses a front view 102 of the driver license card 100 and FIG. 1(b) shows back view 104 of the driver license card 100. Both the front and back view includes confidential information 108 such as name, signature, address, birth date, driver's license number, and the like, that needs to be protected from unauthorized individuals, which if revealed could lead to misuse of the owner's data. Further, the non-confidential information 106 such as user photo, vehicle type, date, etc. are generally more public and less private user details, which if exposed may not cause significant problems for the owner.

In one embodiment of the present invention, the sample card can be any other cards such as Identification cards, Driver License, Passport, Credit and Debit Cards, Gift cards, frequent traveler cards, loyalty cards, passport cards, etc. Accordingly, the confidential information 108 may be user name, account number, credit card/debit card number, card expiry, user signature, date of birth, gift voucher ID, etc. and the non-confidential information 106 can be user photo, bank name, bank logo, issuing agency and the like.

FIG. 2 illustrates a front view of the card cover or carrier of the present invention in accordance with the disclosed architecture. The card cover 120 is generally rectangular in shape and comprises of a front panel 122 and a back panel 124 having one or more protective, concealment or gray or black out surface area 126 and one or more transparent or translucent areas 128. Both the panels may have multiple portions 126, which has dark texture in order to hide the sensitive card information covered by the overprinting, coated, black or gray-out portion(s). The dark textured gray or black out portion(s) 126 renders the information generally unreadable or inaccessible for any unauthorized person. Multiple concealment or black or gray-out portions 126 can be present on the card cover to hide different areas of confidential information on the card 100 and each of the areas may vary in length or width from one another depending on the intended areas of the confidential information to be concealed. Further, the one or more transparent or translucent areas 128 provides a see-through view for the users to easily view the non-confidential information on the card 100. Further, the transparent portion 128 allows for the visual identification of the card 100 contained within the card cover 120 through the front panel 122, such as areas including the user's photo or issuing agency logo. The gray or black-out areas and transparent portions are present on specific sections of the card cover 120 based on the specific card 100 requirements or designs. For example, different card covers or card carriers can be provided depending on the type of card and the specifications it has. A driver's license will have a need to have different concealment portions than a credit card. Card cover 120 may be customized to have different shape, style, size, placement of gray-out and transparent portion, multiple gray-out areas based on the a specific card of the user. The size of most credit cards is 85.60 mm×53.98 mm (3⅜×2⅛ inches) and rounded corners with a radius of 2.88-3.48 mm, conforming to the ISO/IEC 7810 ID-1 standard, the same size as ATM cards and other payment cards, such as debit cards. Driver licenses specifications can vary by the issuing state, country or other organization. As with other cards, the shape and size may vary depending on the preferences of the particular issuing entity.

The front panel 122 and the back panel 124 includes a top edge 132, a bottom edge 134, a left edge 136 and a right edge 138, which form a generally rectangular card cover shape 120. The dimensions of the panels and side edges are generally configured to be in alignment with the published card specifications or other guidance from the card manufacturer. In a preferred embodiment of the present invention, the top edge 132 of the front and back panel of the card cover or carrier is unsealed to provide an opening 1321 to receive the card 100 through the opening and a cut-out portion 130 or detent, extending generally into the body of the card cover panels, to enable the fingers of the user to quickly take out the card 100 from the card cover 120. The card 100 slips inside the card cover 120 through the opening 1321 present on the top edge 132 and fits into the card cover 120. The cut-out area 130 is a semi-circular cut or detent on the top edge 132 of one or both of the front and back panels, which facilitates the user to access the card and easily take out the card 100 from the cover or carrier 120. In an alternate embodiment, the cut-out area 130 and the opening 1321 may be present on any of the edges as per the convenience of the user and requirements of the card.

In a further embodiment of the present invention, the improved card covers 120 may be constructed from various materials, including a non-adhesive plastic film, flexible conformable polymeric sheets such as thermoplastic rubber, PET or other similar materials. The cover 120 normally comprises a single layer of material, or it may be comprised of two or more layers of the same or different materials to strengthen the card cover and to change the level of transparency or translucency of the card carrier. The material is preferably durable and water-resistant to protect the card from tampering due to exposure to rain, and improper handling of the cards contained within the carrier or cover. The card cover 120 is thin enough to be easily accommodated into user's wallet or pockets, with the card kept inside it, that is the carrier or cover does not increase the overall dimension of the card so that it is unable to fit within a wallet or purse compartment configured to hold the card. The covers 120 may be available in various sizes and styles to accommodate any type of personal identification card or other card that a user may have and wish to have information protected on the cover. Exact size, measurement, construction, and design specifications may vary upon further development and manufacturing.

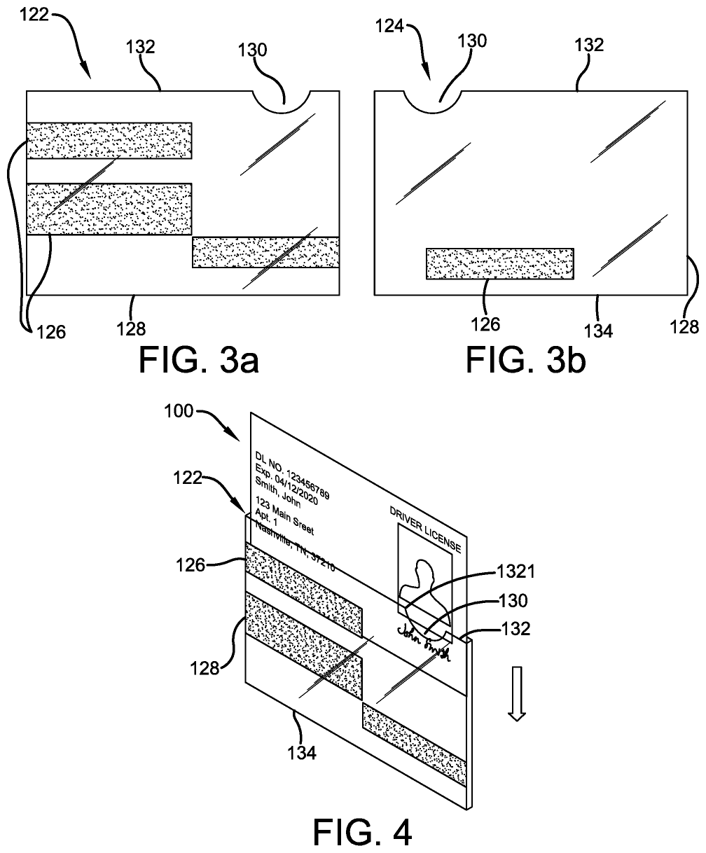

FIG. 3 illustrates the front-panel and the back-panel of the card cover 120 of the present invention in accordance with the disclosed structure. As shown in FIG. 3(a), the front-panel 122 is designed as per the example of the sample driver license card front 102 of FIG. 1(a). The back-panel of FIG. 3(b) is designed as per the example of the sample driver license card back 104 of FIG. 1(b). It should be understood that each state, country, municipality, etc., issued driver's license card may have different configurations depending on the issuing body's specifications. The card cover or carrier is manufactured by joining or sealing the rectangular shaped front panel 122 and back panel 124 together such that the top edge 132, bottom edge 134 and the cut-out portion 130 overlaps and are connected with each other along at least two of the four edges and preferably along three of the four edges. Further, while joining the card panels 122 and 124, an opening is provided on the top edge 132 of each of the front and back panel to provide a space or a pocket to insert the card 100 into the card cover 120.

The card cover panels 122 and 124 have one or more concealment, black our or gray-out portions 126 and one or more transparent or translucent portions 128 based on the placement of information on the sample driver license card 100 of FIG. 1. The concealment or black our gray-out areas 126 and transparent or translucent 128 areas are designed to overlap the confidential information 108 and non-confidential information 106, respectively. The placement of the portions 126 and 128 are not limited, and can be designed to accommodate any type of personal identification card and other styles of various cards based on the specifications of the issuing agency. The shape of the concealment areas, my be rectangular to for example cover the height and length of a driver's license number, birth date or other sensitive information and may vary in length depending on the shape of, size and length of the information. For example, the birth date information may be in a format of MM/DD/YYYY and may be 10 characters in length, whereas a driver's license or may be more or less than 10 characters in length. The concealment areas can be squares, rectangles, dots, or other geometric patterns.

FIG. 4 illustrates a perspective view of inserting a card through an opening of the card cover or carrier of the present invention in accordance with the disclosed structure. FIG. 4 shows a step of inserting a card 100 by the user through an opening 1321 on the top edge 132 of the card cover 120. The card cover 120 is designed such that the card easily slips inside the cover 120 and fits well in it. That is, the material selected for the card cover or carrier will not stick or cling to the surface of the card and allow easy insertion and removal of the card. Alternatively, the card cover or carrier material may also be provided with anti-stick or anti-cling coatings to facilitate removal and insertion of the card. The specifications of the card cover are in conformity with the card specifications.

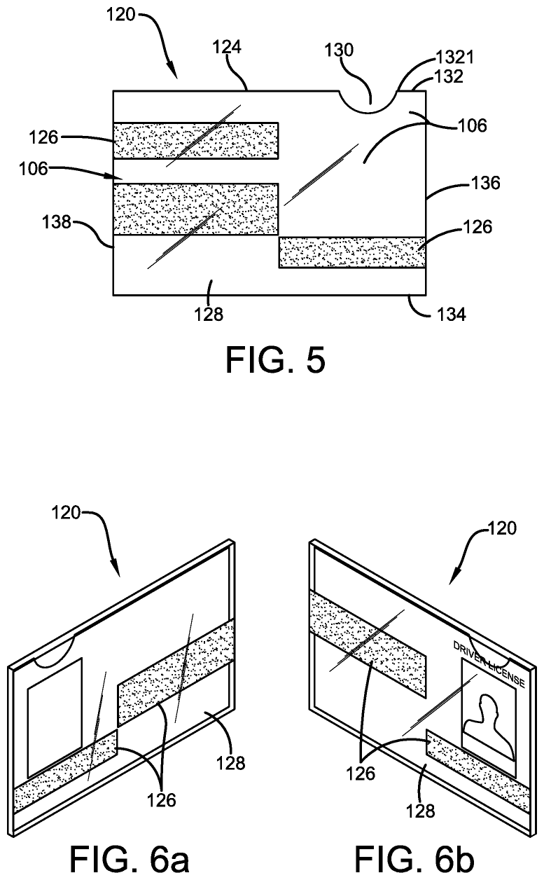

FIG. 5 illustrates a front view of a card 100 inside the card cover 120 hiding confidential information 108 and displaying non-confidential information 106 for use of the present invention in accordance with the disclosed architecture. The card 100 fits inside the card cover 120 such that the concealment or black or gray-out area 126 hides the confidential information 108 such as name, address, Driver's License number, user signature, etc. behind it and does not allow any unauthorized person to steal confidential information and further misuse the user's information. The transparent area 128 provides a visible area for users such that the non-confidential information 106 such as user's photo, ID type, issuing agency logo, etc. can be viewed by user and others. The transparent or translucent area 128 enables the user to recognize the card 100 at the time of use. In a similar manner, the concealment, black or gray-out portion 126 on the back panel 124 of the card cover 120 hides the confidential information 108 such as user signature present on the card back 104 (not shown). Further, the transparent or translucent portions 128 on the back panel 124 of the card cover 120 shows the non-confidential information 106 such as vehicle type, date, etc.

FIGS. 6a-b illustrate different designs of card covers or carriers of the present invention in accordance with the disclosed structure. The card cover or carrier 120 may comprise multiple gray-out portions 126 and transparent or translucent portions 128, as per the example of different cards used by the user or users. Further, shown in the FIG. 6, the cut-out portion or portions can also be placed at any of the sides of different edges of the card cover 120.

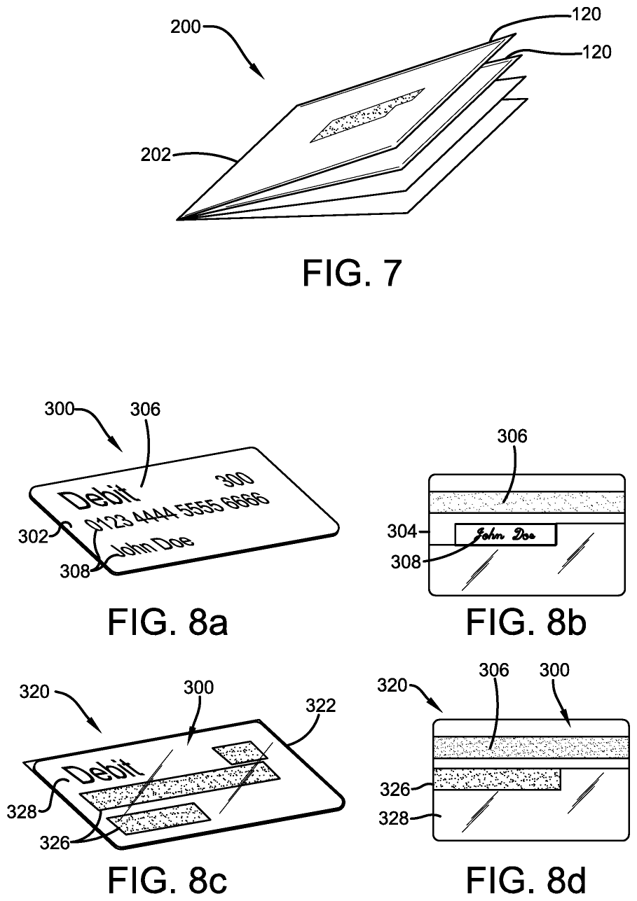

FIG. 7 illustrates a multi-sleeve protective card cover 200 structure of the present invention in accordance with the disclosed structure. A plurality of single or individual protective covers 120 catering to different types of cards 100 may also be bound together along one edge common 202 to all the individual units of single protective covers.

FIG. 8a-8d illustrate various embodiments of a debit card 300 and a protective card cover 320 with the debit card 300 placed inside the cover. A front panel sheet 322 and a rear panel sheet 324 are placed in substantial congruent, overlapping relation to one another and has one open edge (not shown) to form a pocket or opening between the front panel sheet 322 and the rear panel sheet 324 for receiving the debit card 300 and to allow repeated insertion and removal of the debit card 300. The front panel sheet 322 and rear panel sheet 324 includes one or more concealment or black or gray-out or protective areas 326 to hide the sensitive information 308 on the card 300 and one or more translucent or transparent portions 328 to allow users to view the non-confidential user information 306 on the card 300. The debit card front surface 302 includes the sensitive information 308, the user's name, account number or card number, security code or the like. The front panel sheet 322 substantially obscures the personal sensitive information 308 such as the user's name, account number or card number, security code, etc. leaving all other information 306 such as an image, issuing agency logo or the like uncovered. Similarly, the debit card front surface 304 may have user's signature and a magnetic strip. The rear panel sheet 324 obscures the user's signature, and the magnetic strip may remain clear and uncovered.

The exact position and size of the concealment or black or gray-out areas on either the front, rear, or both surfaces of the protective card cover depend upon the design or specifications of the information bearing surface of the card insert. The concealment or gray-out areas or strips is customized to fit the particular layout of the information bearing surface of the card insert such that the concealment or gray-out areas or strips which sits directly on top of the desired or selected information on the card insert, for example, the address of the bearer, that needs to be blocked off when the insert is entirely inside the protective card cover.

The present invention has a wide range of applications various types of cards such as Personal identification cards, Credit Cards, Debit Cards, Gift Cards, etc. to protect the confidential information from unauthorized users such as pedestrians, bystanders, retail employees, other customers at the location where the card is being used, etc. The invention provides a secure way to protect a specific card from tampering and revealing relevant user information to others.

The card cover, maintains the functionality of the enclosed card by allowing a magnetic stripe, a QR code, an NFC chip and the like to be read by a machine, device, scanner and the like from the card that is not recognizable to the naked eye and the personal confidential information is kept hidden even during transactions in public. The user does not have to remove the card from the privacy card cover. When scanning the QR code, stripe or other bar code the card cover or card carrier will have sufficient transparency or translucency in the area where the information is to be scanned or read as a scanner requires a “line of sight” to read the code and a card stripe reader to read the magnetic stripe. The NFC chip should not be impacted by the card carrier or cover as the NFC chip should be sufficiently readable by the proximity the card is placed to the chip reader.

The disclosed embodiments pertain to privacy card covers that incorporate protective film, concealment or black or gray-out areas to prevent identity theft or unauthorized viewing of the confidential information on a card. A privacy card cover according to the disclosed embodiments is separate from the card itself. The privacy card cover is an aftermarket item to be purchased and attached to a card.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “card cover”, “privacy card cover”, “improved card cover”, “card cover device”, “card holding device”, “unique card cover”, “card holder”, “card carrier” and “card sleeve” are interchangeable and refer to the card cover 120 of the present invention. As used herein “black or gray-out portion,” “concealment” and “black or gray-out area” are used interchangeably to describe a dark textured area of the card cover 120.

Notwithstanding the forgoing, the card cover or card carrier (120) of the present invention can be of any suitable size, shape, style, and configuration as is known in the art without affecting the overall concept of the invention, provided that it accomplishes the above stated objectives. One of ordinary skill in the art will appreciate that the shape and size of the card cover (120) as shown in the FIGS. are for illustrative purposes only, and that many other styles, shapes and sizes of the card cover (120) are well within the scope of the present disclosure. Although the dimensions of the card cover 120 are important design parameters for user convenience and card requirements, the card cover 120 may be of any size that ensures information protection during use and that suits user need and/or preference.

Although embodiments for the present subject matter have been described in language specific to structural features, it is to be understood that the present subject matter is not necessarily limited to the specific features described. Rather, the specific features and methods are disclosed as embodiments for the present subject matter. Numerous modifications and adaptations of the system/component of the present invention will be apparent to those skilled in the art, and thus it is intended by the appended claims to cover all such modifications and adaptations which fall within the scope of the present subject matter.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A card cover, comprising;
front and back panels sized and configured to substantially cover a card, each of the front and back panels have top and bottom edges and left and right side edges with at least two of the top and bottom edges and left and right side edges being secured together;
the card having at least one area having confidential information and one or more areas having non-confidential information; and
at least one concealment or black or gray out area provided on one of the front and back panels, the at least one concealment or black or gray out area being sized and configured to cover the at least one area of confidential information.

2. The card cover of claim 1, wherein each of the front and back panels have at least one transparent or translucent area and the at least one transparent or translucent area covering the one or more areas of non-confidential information.

3. The card cover of claim 1, wherein at least one of the front and back panels has a cut out portion or recess along one of the top, bottom, left or right side edges.

4. The card cover of claim 3, wherein the cut out or recess portion is provided along each of the top edges of the front and back covers.

5. The card cover of claim 1, wherein there are multiple concealment or black or gray out areas on at least one of the front and back covers.

6. The card cover of claim 1, wherein the multiple concealment or black or gray out areas have different sizes.

7. The card cover of claim 1, wherein each of the right and left side edges are sealed to one another.

8. The card cover of claim 1, wherein the bottom edges of the front and back panel are sealed together.

9. The card cover of claim 3, wherein the cut out or recessed portion is provided along the top edge and adjacent a corner of the top and bottom edge.

10. The card cover of claim 1, wherein the top edge of the front and back panels combine to form an opening for insertion of the card between the front and back panels.

11. A card cover and card combination, comprising;
a card having front and back panels with information relating to a user disposed on at least one of the front or back panels and information relating to a card issuer disposed on one of the front or back panels of the card, the information relating to the user being at least partly confidential personal information and the information relating to a card issuer being generally non-confidential information;
a card cover having front and back panels with each of the panels having top, bottom, left and right edges and the card cover being sealed along at least two of the edges;
the card cover having at least one concealment area and at least one transparent area; and
the at least one concealment area covering the partly confidential personal information and the at least one transparent area covering the generally non-confidential information.

12. The card cover and card combination of claim 11, wherein there are multiple concealment areas and multiple transparent areas.

13. The card cover and card combination of claim 12, wherein the multiple concealment areas have different sizes.

14. The card cover and card combination of claim 12, wherein the multiple transparent areas are in areas nots covered by the multiple concealment areas.

15. The card cover and card combination of claim 11, wherein a recess or cut out portion is provided along the top edges of the front and back panels of the card cover.

16. The card cover and card combination of claim 11, wherein the partly confidential personal information includes account numbers, birth dates, security codes and combinations thereof.

17. The card cover and card combination of claim 11, wherein the generally non-confidential information includes issuing agency logos, names, photos and combinations thereof.

18. A card carrier, comprising,
at least two card covers with each of the card covers having front and back panels with each of the panels having top, bottom, left and right edges and the card cover being sealed along at least two of the edges;
each of the card covers having at least one concealment area and at least one transparent area; and
the at least one concealment area covering the partly confidential personal information and the at least one transparent area covering the generally non-confidential information; and
the at least two card covers being secured to one another along on of the top, bottom, left and right edges to form a card carrier for multiple cards.

19. A card carrier as recited in claim 18, wherein there are three or more card covers and each of the card covers is provided with a card having front and back panels with information relating to a user disposed on at least one of the front or back panels and information relating to a card issuer disposed on one of the front or back panels of the card, the information relating to the user being at least partly confidential personal information and the information relating to a card issuer being generally non-confidential information.

20. A card carrier as recited in claim 18, wherein each of the card carriers is provided with multiple concealment areas and multiple transparent areas.
